(19) United States
(12) Patent Application Publication
(10) Pub. No.: US 2026/0111260 A1
(43) Pub. Date: Apr. 23, 2026

(54) ADAPTIVE MACHINE-LEARNING-MODEL PROCESSING FOR WORKLOAD TYPES

(71) Applicant: Snowflake Inc., Bozeman, MT (US)

(72) Inventors: Vincent Chan, Bellevue, WA (US); Zhaotian Wang, Newark, CA (US)

(21) Appl. No.: 18/923,049

(22) Filed: Oct. 22, 2024

(51) Int. Cl. G06F 9/48

(52) U.S. Cl. CPC G06F 9/4881

(57) ABSTRACT

Described is a system for responding to an interactive request by receiving an interactive request from a user through a communication interface on a data platform, the request including a question needing a response. A priority query request is generated based on the user's input, with a defined latency requirement specifying the maximum time allowed for generating the response. In order to meet this latency requirement, the batch size for processing on a graphical processing unit (GPU) handling multiple workloads of a large language model (LLM) is reduced. The priority query request is then inserted into the current batch being processed by the GPU, which is adjusted based on the reduced batch size. The response is generated by the GPU and subsequently displayed to the user through the communication interface

### TECHNICAL FIELD

Embodiments of the disclosure relate generally to cloud data platforms and, more specifically, to adaptive machine learning model processing for different workload types.

### BACKGROUND

Network-based database systems may be provided through a cloud data platform, which allows organizations, customers, and users to store, manage, and retrieve data from the cloud. With respect to this type of data processing, a cloud data platform could implement online transactional processing, online analytical processing, and/or another type of data processing. Moreover, a cloud data platform could be or include a relational database management system and/or one or more other types of database management systems.

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to types of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. Indeed, the data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 illustrates an example computing environment that includes a cloud data platform, according to some examples.

FIG. 2 is a block diagram illustrating components of a compute service manager of the cloud data platform, according to some examples.

FIG. 3 illustrates an example routine for generating a response to an interactive request, according to some examples.

FIG. 4 illustrates an architectural diagram illustrating scheduling tasks into a current batch for a GPU, according to some examples.

FIG. 5 illustrates an architectural diagram illustrating new incoming requests added to the scheduler, according to some examples.

FIG. 6 illustrates an architectural diagram illustrating the processing of tasks via a first LLM replica and no tasks processed by a second LLM replica, according to some examples.

FIG. 7 illustrates an architectural diagram illustrating the application of latency requirements and strategic distribution of tasks and batch sizes responsive to new incoming tasks, according to some examples.

FIG. 8 illustrates training and use of a machine-learning program, according to some examples.

FIG. 9 illustrates a machine-learning pipeline, according to some examples.

FIG. 10 illustrates a diagrammatic representation of a machine in the form of a computer system within which a set of instructions may be executed for causing the machine to perform any one or more of the methodologies discussed herein, according to some examples.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

In the present disclosure, physical units of data that are stored in a data platform—and that make up the content of, e.g., database tables in user accounts—are referred to as micro-partitions or partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, on, etc.) what is referred to herein as an “internal storage location.” If stored external to the data platform, a given file is referred to herein as an “external file” and is referred to as being stored in (or at, on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, eXtensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a user account. The data platform may include one or more databases that are respectively maintained in association with any number of user accounts (e.g., accounts of one or more data providers or other types of users), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular user accounts as well. Users and/or executing processes that are associated with a given user account may, via one or more types of clients, be able to cause data to be ingested into the database, and may also be able to manipulate the data, add additional data, remove data, run queries against the data, generate views of the data, and so forth.

In an implementation of a data platform, a given database (e.g., a database maintained for a user account) may reside as an object within, e.g., a user account, which may also include one or more other objects (e.g., users, roles, privileges, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

A data platform (e.g., database system) can support data storage for one or more different organizations (e.g., customer organizations, which can be individual companies or business entities), where each individual organization can have one or more accounts (e.g., customer accounts) associated with the individual organizations, and each account can have one or more users (e.g., unique usernames or logins with associated authentication information). Additionally, an individual account can have one or more users that are designated as an administrator for the individual account. An individual account of an organization can be associated with a specific cloud platform (e.g., cloud-storage platform, such as such as AMAZON WEB SERVICES™ (AWS™), MICROSOFT® AZURE®, GOOGLE CLOUD PLATFORM™), one or more servers or data centers servicing a specific region (e.g., geographic regions such as North America, South America, Europe, Middles East, Asia, the Pacific, etc.), a specific version of a data platform, or a combination thereof. A user of an individual account can be unique to the account. Additionally, a data platform can use an organization data object to link accounts associated with (e.g., owned by) an organization, which can facilitate management of objects associated with the organization, account management, billing, replication, failover/failback, data sharing within the organization, and the like.

In existing systems that process tasks using large language models (LLMs) on GPUs, the systems are optimized for latency or throughput, but struggle to balance both effectively. For instance, batch processing systems prioritize throughput by processing large numbers of tasks simultaneously, often resulting in long waiting times for individual tasks, which is problematic for latency-sensitive tasks such as real-time user queries.

Another deficiency in current systems is the static allocation of resources. In many setups, tasks are assigned to GPUs in a fixed manner, which can lead to inefficiencies. GPUs may become overloaded with tasks, slowing down the processing time for high-priority requests, while GPUs dedicated to running latency sensitive requests may remain underutilized. In some cases, a high priority request can include a request that is latency sensitive with a desired or required response time.

Aspects of the present disclosure address the foregoing issues, among others, with a data platform, systems, methods, and devices by introducing an adaptive and intelligent LLM-task optimizer that dynamically manages and balances both latency-sensitive and throughput-focused tasks.

Unlike traditional systems, which often prioritize either speed or volume, the data platform described herein can adjust in real time to handle both types of tasks effectively. When latency-sensitive tasks (such as real-time user queries) are identified, the batch size on the GPU is reduced, ensuring that these tasks are processed quickly and meet strict response time requirements.

At the same time, non-urgent batch tasks are handled in larger groups to maximize throughput, allowing the data platform to process extensive datasets or other bulk operations efficiently without delaying high-priority tasks.

Additionally, the data platform improves resource allocation by dynamically distributing tasks across multiple GPU nodes based on their current load and the nature of the tasks. This improves on GPU under or over utilization, as tasks are intelligently reassigned to balance the workload. For example, time-sensitive tasks may be prioritized on one GPU while large-scale batch tasks are shifted to another, optimizing GPU utilization.

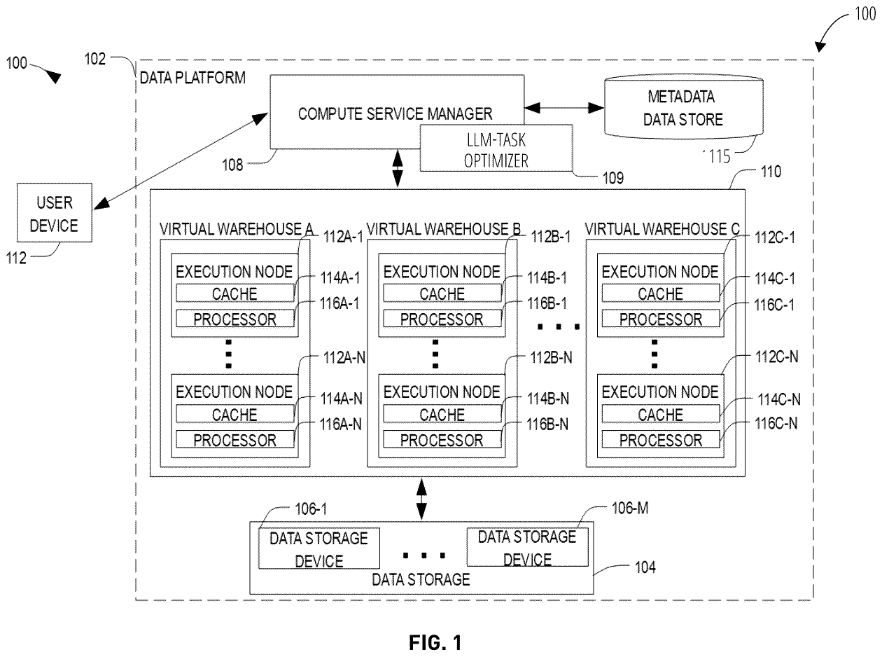

FIG. 1 illustrates an example computing environment 100 that includes a cloud data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the cloud data platform 102 comprises a three-tier architecture: a compute service manager 108 coupled to a metadata data store 115, an execution platform 110, and data storage 104. The cloud data platform 102 hosts and provides data access, management, reporting, and analysis services to multiple client accounts. Administrative users can create and manage identities (e.g., users, roles, and groups) and use permissions to allow or deny access to the identities to resources and services. The cloud data platform 102 is used for reporting and analysis of integrated data from one or more disparate sources including storage devices within the data storage 104. The data storage 104 comprises a plurality of computing machines and provides on-demand computer system resources such as data storage and computing power to the cloud data platform 102.

The compute service manager 108 includes multiple services that coordinate and manage operations of the cloud data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

As shown, the compute service manager 108 includes an LLM-task optimizer. The LLM-task optimizer optimizes the distribution and scheduling of tasks for large language model (LLM) processing across available GPU resources. The LLM-task optimizer dynamically adjusts how tasks are assigned to different GPUs based on factors such as latency requirements, task priority, and throughput optimization to balance the speed at which time-sensitive, interactive tasks are processed with the efficient handling of larger, non-urgent batch tasks.

The LLM-task optimizer adjusts the batch size on GPUs based on the nature of incoming tasks. For latency-sensitive tasks, the optimizer reduces the batch size to ensure quicker response times, allowing high-priority tasks to be processed faster. For non-time-sensitive tasks, the optimizer increases the batch size to maximize GPU utilization and throughput. Further details of the operation of the LLM-task optimizer 109 are discussed below.

The compute service manager 108 is also in communication with a user device 112. The user device 112 corresponds to a user of one of the multiple client accounts supported by the cloud data platform 102. In some implementations, the compute service manager 108 does not receive any direct communications from the user device 112 and only receives communications concerning jobs from a queue within the cloud data platform 102.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution nodes 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution nodes 112B-1 to 112B-N; execution node 112B-1 includes a cache 114B-1 and a processor 116B-1; and execution node 112B-N includes a cache 114B-N and a processor 116B-N. Additionally, virtual warehouse C includes execution nodes 112C-1 to 112C-N; execution node 112C-1 includes a cache 114C-1 and a processor 116C-1; and execution node 112C-N includes a cache 114C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the cloud data platform 102 based on the changing data storage/retrieval needs as well as the changing needs of the users and systems. The support of dynamic changes allows the cloud data platform 102 to scale quickly in response to changing demands on the systems and components within the cloud data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 115 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 115, execution platform 110, and data storage 104 are shown in FIG. 1 as individual discrete components. However, each of the compute service manager 108, metadata data store 115, execution platform 110, and data storage 104 may be implemented as a distributed system (e.g., distributed across multiple systems/platforms at multiple geographic locations). Additionally, each of the compute service manager 108, metadata data store 115, execution platform 110, and data storage 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

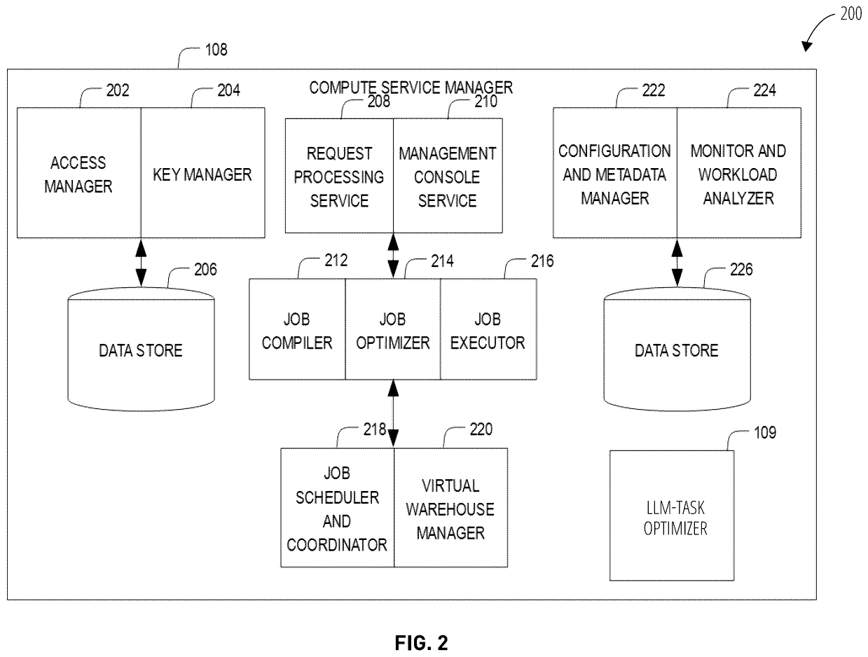

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the cloud data platform 102. For example, data store 226 may represent caches in execution platform 110, storage devices in data storage 104, the metadata data store 115, or any other storage device or system.

In addition, as mentioned above, the compute service manager 108 includes an LLM-task optimizer 109 that is responsible for intelligently managing and optimizing the allocation of tasks across GPU resources in systems running LLMs. The LLM-task optimizer dynamically adjusts how tasks are scheduled and processed, taking into account various factors such as task priority, latency requirements, and GPU availability.

For tasks with strict latency constraints, such as real-time or interactive requests, the LLM-task optimizer reduces the batch size on GPUs to ensure faster processing times, allowing these high-priority tasks to be executed with minimal delay. Conversely, for tasks that are non-time-sensitive, such as large batch jobs, the LLM-task optimizer increases the batch size to maximize throughput and efficiently utilize GPU resources without the need for immediate response times.

The optimizer also performs load balancing, ensuring that workloads are evenly distributed across multiple GPU nodes. For instance, if one GPU is handling latency-sensitive tasks, the optimizer can offload larger, non-urgent tasks to another GPU, preventing any single resource from becoming a bottleneck. By managing both the prefill phase (where input tokens are prepared for processing) and the decoding phase (where output tokens are generated), the LLM-task optimizer ensures that tasks are seamlessly moved between these stages and that resources are optimally used. Ultimately, this module enhances the overall system by improving efficiency, scalability, and responsiveness in environments where both real-time and batch processing tasks coexist. Further details regarding the functionality of the LLM-task optimizer 109 are discussed below.

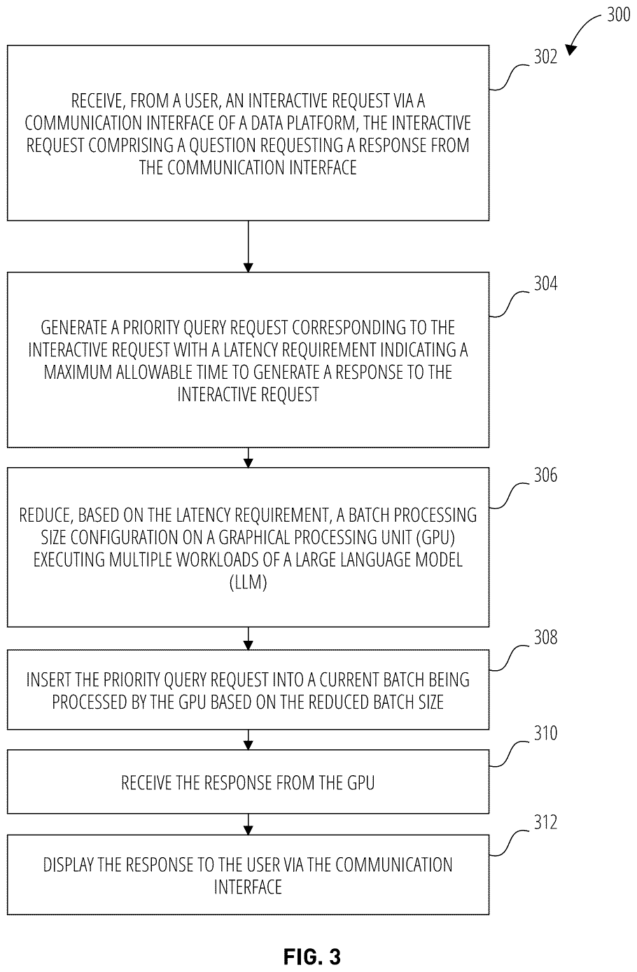

FIG. 3 illustrates an example routine 300 for generating a response to an interactive request, according to some examples. Although the example routine 300 depicts a particular sequence of operations, the sequence may be altered without departing from the scope of the present disclosure. For example, some of the operations depicted may be performed in parallel or in a different sequence that does not materially affect the function of the routine 300. In other examples, different components of an example device or system that implements the routine 300 may perform functions at substantially the same time or in a specific sequence.

FIG. 3 is described as being performed by certain systems or applying certain processes, such as a particular machine learning model or LLM, but the processes described herein can be performed by one or more other or the same machine learning models or LLMs.

At operation 302, the data platform 102 receives, from a user, an interactive request via a communication interface of a data platform, the interactive request comprising a question requesting a response from the communication interface. The user can be engaging with the platform through a communication interface, such as a chat window in a web-based chat interface, a messaging application, a voice assistant interface, and/or the like.

This interaction can occur in real-time, where the user expects a quick, interactive response from the platform. The interface can capture the user's input and identify whether the input includes simple text to more complex requests.

The data platform initiates a chat message comprising a user interface configured to receive prompts from a first user. The data platform initiates display of the interactive component through which users can input their queries or commands, allowing the system to interact with the users effectively.

The UI is configured to receive multiple types of inputs from the user. These inputs can include text queries, commands, voice inputs, or the like depending on the configuration of the data platform. The platform manages user sessions and prompts to maintain context throughout the interaction. This includes tracking the history of prompts and responses, enabling a seamless conversational flow.

The UI includes an input field where users can type their queries or commands. This field may include features such as autocomplete suggestions and error correction to enhance user experience. Autocomplete suggestions help users by predicting the rest of their query as they type, speeding up the input process and reducing errors. The data platform can maintain a database of commonly asked questions and phrases relevant to the domain of the chat application. This database can be built from historical data of similar users or the particular user, or designed based on anticipated user needs.

In some embodiments, the data platform uses predictive text algorithms that analyze the initial characters typed by the user and match them with the most likely completions from the database. These predictive text algorithms can leverage machine learning models trained on a large corpus of text to improve prediction accuracy. The data platform can execute real-time processing to provide suggestions instantly as the user types.

The user interface can include an area where responses generated by the system are displayed. This area updates dynamically as the conversation progresses. The user interface can include interaction buttons for common actions such as submitting a query, clearing the input field, or accessing help and support.

The data platform can receive a plurality of prompts from the user, the plurality of prompts comprising a first query. The data platform is designed to handle multiple user inputs, or “prompts,” that collectively form a history of queries from the user. The data platform maintains a session for each user, tracking the sequence of prompts within a conversation.

The series of prompts provided by the user give context to subsequent prompts. Each prompt is stored in a database or in-memory data structure, indexed by session ID and timestamp. This ensures that the order of prompts is preserved, which is essential for understanding context.

As the user enters prompts, the system processes each one in real-time, appending the latest prompt to the current session's context. This immediate processing allows for dynamic interactions and adjustments based on new inputs. As an example, if a user is interacting with a financial data platform and the user's prompts are as follows: Prompt 1: “Show me the quarterly earnings for Q1 2023.” Prompt 2: “How does this compare to the previous quarter?” Prompt 3: “And what about the same quarter last year?” In this example, the data platform receives three prompts that collectively provide context for a more comprehensive query about quarterly earnings and their comparisons over different periods.

The data platform assesses prompts to identify a query. In some embodiments, the data platform also categorizes the prompts. This categorization process helps the data platform to determine whether the prompt requires data retrieval from a third-party dataset or if the prompt can be responded to by a Large Language Model (LLM) directly.

For example, the data platform classifies the prompts into three distinct categories. The first category can include a conversational prompt that do not require any search or retrieval from an indexed database. For instance, greetings or simple expressions of courtesy fall into this category. When a prompt is categorized as such a pleasantry, the data platform can immediately request an LLM to provide a quick and fast response, ensuring a seamless conversational flow without unnecessary delays.

Prompt categories can include a dataset-specific question, where these prompts specifically ask for information that needs to be retrieved from a database. For example, if a user queries specific data points or trends within a dataset, the system recognizes the need for database retrieval to generate an accurate response. In this case, the system initiates the necessary search processes, as further described herein, to fetch the relevant data from the indexed tables or databases.

Prompt categories can include questions on metadata, where this category includes queries about the dataset's metadata or general knowledge about the data. For example, if a user asks about the type of data available or how to interact with the dataset, the system categorizes such prompts as a metadata question. This type of prompt involves providing information about the dataset's structure, available fields, or how to perform specific queries, and as such, initiates the necessary search processes, as further described herein.

To efficiently handle this categorization, the data platform can apply a separate machine learning model, such as a smaller LLM, which specializes in classifying prompts into these categories. By leveraging this categorization step, the data platform can quickly determine the appropriate action for each prompt. If a prompt is classified as a pleasantry, the system can bypass the search index and directly generate a response using the LLM. For dataset-specific questions and metadata inquiries, the system proceeds with the document or text retrieval processes as described herein, ensuring that users receive accurate and relevant information based on their queries.

At operation 304, the data platform 102 generates a priority query request corresponding to the interactive request with a latency requirement indicating a maximum allowable time to generate a response to the interactive request. The data platform can translate the user's query into a format that the LLM can process, while also ensuring that the query is treated with the appropriate urgency by assigning the query with a latency requirement.

After the data platform has received the interactive request (as described in operation 302), the data platform analyzes and interprets the request, such as by parsing the user's natural language question to determine its nature and complexity. The platform determines that this is a real-time, interactive request, meaning that the user is awaiting an immediate response. Based on this, the platform assigns the request a latency constraint.

The platform converts the user's original question or text into a priority query request. The data platform transforms the user's question (in natural language) a structured request that the LLM can handle, such as parsing the question to extract key entities (e.g., “What is the weather in New York?”), where “New York” is an entity, assigning metadata to the request, such as request type (e.g., a query for information or a command for action), mapping the request to the appropriate backend services or models (e.g., sending it to a specific large language model or database query service), and/or the like.

In some examples, the data platform assigns a latency requirement to the priority query request. This latency requirement represents a maximum allowable time in which the platform must generate a response to the user's interactive request. For example, if a user asks, “What is the current stock price of XYZ?”, the system may assign a latency requirement of 500 milliseconds or 5 seconds to ensure a fast response.

The data platform can determine the latency requirement based on one or more factors. For example, the data platform can determine the latency requirement based on the content of the question. Certain queries, such as searching for information or quick decision-making assistance (e.g., weather updates or stock prices), may have stricter latency requirements compared to more complex analytical queries (e.g., data reports). This is because real-time information or decisions can have an immediate impact, while detailed analytical queries may allow for more flexible response times. Queries that are mission-critical or time-sensitive can be prioritized accordingly to maintain user satisfaction.

The data platform can determine the latency requirement based on user priority. For example, high-priority users, such as premium or paying customers, may have stricter latency requirements to ensure faster service compared to standard users, based on service level agreements (SLAs). These agreements ensure that higher-tier users receive superior performance, thus improving their overall experience and maintaining their trust in the platform. In enterprise contexts, this could also mean differentiating response times based on the importance of a customer's business or account.

The data platform can determine the latency requirement based on the complexity of the request. For example, simpler requests with fewer data dependencies (e.g., looking up a fact) may require lower latency than complex, multi-step queries that involve significant computation or data gathering (e.g., generating custom reports). Complex queries may involve retrieving data from multiple sources or performing calculations, which inherently take more time. As a result, the platform can allocate more time to ensure accurate responses, while still striving for efficiency in simpler queries.

The data platform can determine the latency requirement based on system load. When the system is under heavy load, the platform may adjust the latency requirement for non-urgent requests, relaxing the time frame to ensure critical tasks are prioritized. This dynamic adjustment helps in managing resources more effectively, ensuring that high-priority or latency-sensitive requests are not delayed due to background processes or batch tasks. During peak times, this balancing act ensures optimal performance for many users without system overload. For example, the latency requirement can be determined based on a current size of a queue in a scheduler for the GPU.

The data platform can determine the latency requirement based on response type. Real-time conversational responses (e.g., a chatbot response) require low latency, while offline data processing (e.g., email summaries or reports) can have higher latency requirements. This distinction ensures that users engaging in interactive sessions experience seamless, real-time interactions, which is critical for maintaining engagement and providing an intuitive user experience. Conversely, tasks with more relaxed deadlines, such as report generation, are processed as resources become available, reducing strain on the system.

The data platform can determine the latency requirement based on historical query patterns. If the system has observed that certain types of queries or users tend to expect rapid responses, historical data may influence latency requirements, setting stricter constraints for similar requests. This predictive approach can use a machine learning model trained to anticipate user needs, allowing the platform to allocate resources more efficiently in the future. The model also helps in improving the overall system's responsiveness by learning from past interactions and adjusting accordingly.

The data platform can determine the latency requirement based on the geographical location of the user, where users closer to the data center may have stricter latency constraints due to expected faster network speeds, while users farther away may have relaxed latency due to network delays. The data platform can determine the latency requirement based on the nature of the service or application, where interactive services such as virtual assistance require low-latency responses to maintain real-time interaction, while backend processes (e.g., data aggregation) can tolerate longer delays. Geographical proximity directly impacts network latency, meaning users closer to the infrastructure will have higher expectations for response speed. Services that rely on maintaining a fluid interaction, such as voice assistants or gaming applications, demand faster responses compared to tasks that run in the background, where delays are more acceptable.

The data platform can determine the latency requirement based on resource availability, where the availability of system resources, such as GPUs, can influence latency requirements. If resources are constrained, the platform may adjust latency requirements for less critical tasks to optimize overall performance. This real-time resource management ensures that critical tasks always have access to the necessary computational power, avoiding performance bottlenecks. By dynamically allocating resources, the platform can continue to meet important deadlines while making sure less urgent tasks are processed efficiently as resources free up.

The data platform can determine the latency requirement based on the time of day. During peak hours or high-traffic periods, the system may increase the latency threshold for less critical requests to ensure critical interactive tasks are still handled within acceptable limits. This time-based prioritization allows the platform to adapt to fluctuating demand throughout the day, ensuring smooth performance during peak usage while still processing less urgent tasks during off-peak times. This helps prevent system overload and ensures a balanced workload distribution.

Although examples described herein explain the determination of a latency requirement and factors the system can consider when determining such a latency requirement, it is appreciated that such factors can be used for other features described herein, such as determining a throughput requirement or a batch size.

Based on the latency requirement, the system marks this request as a priority query. The request is flagged as needing to be processed ahead of other lower-priority tasks which may not have strict timing constraints. The data platform processes such requests as soon as possible, potentially preempting other, less time-sensitive requests that are already in the queue, such as by rearranging the processing order in the queue to ensure this request is handled next, and evicting lower-priority tasks or adjusting resource allocation (such as GPU time) to meet the latency requirement (as further described herein).

Once the priority query request is generated with its latency requirements, the platform prepares the request for execution, such as by packaging the query for submission to the appropriate machine learning models (such as LLMs) or other computational engines (e.g., database engines, analytics services).

At operation 306, the data platform 102 reduces, based on the latency requirement, a batch processing size configuration on a GPU executing multiple workloads of an LLM. The data platform reduces the batch processing size configuration on the GPU to accommodate the latency constraints, ensuring that the platform can meet the required response time for an interactive request.

GPUs can process workloads in batches to optimize performance, as this allows multiple tasks to be handled concurrently, increasing overall throughput. This is particularly useful in tasks such as large language model (LLM) inference, where multiple requests can be grouped together for parallel processing. Larger batch sizes enable the GPU to process more tasks at once, maximizing throughput and efficiently utilizing its computational power.

However, large batch sizes can also increase the latency for individual tasks, especially interactive requests that require a quick response. Processing a large number of tasks simultaneously means that an individual request might have to wait longer before it is executed, which is not ideal for tasks with strict latency requirements, like real-time user queries.

In this operation, the data platform 102 dynamically adjusts the batch size configuration on the GPU based on the latency requirement of the interactive request. If the request has a strict latency requirement (meaning it needs to be processed quickly), the system reduces the batch size to ensure faster processing of that particular request.

By decreasing the number of tasks processed in a single batch, the system can reduce the time that a high-priority request has to wait before being executed and/or even while being executed. Smaller batches mean that the processing queue moves faster, allowing the interactive request to be handled more quickly, thus meeting the latency requirement.

Large Language Models (LLMs) are typically computationally intensive, and executing multiple workloads on the same GPU means that resources need to be managed carefully. Reducing the batch size has an immediate effect on how the GPU allocates its computational resources.

While reducing batch size improves latency for individual requests, such a reduction can also temporary reduce overall throughput because the GPU is processing fewer tasks simultaneously. However, this trade-off is acceptable in scenarios where latency is more important than throughput, such as in real-time conversational agents or urgent user queries.

With smaller batches, the system becomes more responsive to high-priority tasks. This ensures that interactive requests are processed as soon as possible, rather than being delayed by the need to complete a large batch of lower-priority tasks.

The reduction in batch size is not fixed but rather dynamic. The data platform continuously evaluates the latency requirements of incoming requests and adjusts the batch size accordingly. For instance: if a request arrives with a moderate latency requirement, the batch size may only be slightly reduced, balancing between maintaining throughput and meeting the latency goal.

If a request has a strict latency requirement (e.g., a real-time query that needs a response within milliseconds), the batch size may be significantly reduced, or the request could even be prioritized as a standalone task in extreme cases. This flexibility allows the system to optimize the balance between maintaining high throughput for batch tasks and ensuring low-latency responses for interactive queries.

Batch size can be an important parameter in GPU-based processing, especially for tasks involving LLMs, which typically include intensive matrix operations. Larger batch sizes allow the GPU to process more data in parallel, which improves computational efficiency and overall throughput. However, this comes at the cost of increased wait times for individual tasks, as each batch must be completed before moving on to the next one. By reducing the batch size, the system sacrifices some of this efficiency but gains the ability to process high-priority requests faster.

As an example, a user asks a question through a chat interface, such as “What is the latest weather update for my city?” The system assigns a strict latency requirement to this query (e.g., it must respond within 500 milliseconds). At operation 306, the platform determines that the GPU is currently processing a batch of tasks, including lower-priority requests. To ensure the user's query is processed immediately, the system reduces the batch size so that the weather query is prioritized and executed as soon as possible and includes a priority query that corresponds to the user's question into the current batch while evicting one or more tasks from the current batch by placing them back into the scheduler or moving them to another queue (as further described herein), ensuring the response is delivered within the required timeframe.

The platform dynamically balances the need for quick responses with overall system efficiency, adapting the batch size in real time as different types of requests are processed. As described herein, features are described here to reduce latency. However, it is appreciated that such features can be applied to improve other characteristics, such as data throughput.

At operation 308, the data platform 102 inserts the priority query request into a current batch being processed by the GPU based on the reduced batch size. The batch size has already been reduced to accommodate the latency requirement of the priority request.

Batches can include groups of tasks that are processed together by the GPU to maximize computational efficiency. In normal operations, the system handles many tasks simultaneously in a batch, such as when processing workloads for an LLM, which requires substantial GPU resources.

The current batch includes a group of tasks already in the queue, waiting to be processed by the GPU or already being processed by the GPU. At this point, the GPU is actively working on a series of requests, and the batch was previously configured to a certain size, such as based on performance requirements and the availability of system resources.

At this stage, the priority query request—generated earlier based on the user's interactive request and latency requirements—is inserted into the current batch of tasks that the GPU is already processing. This is done to ensure that the priority request gets processed as part of the ongoing batch execution, rather than being delayed until the next batch or processed later as a separate task.

The platform ensures that the priority query request is handled with urgency, and the insertion into the batch is performed in such a way that the GPU can handle the modified batch immediately or as soon as possible, without significantly delaying the other tasks in the batch.

Prior to insertion, the system adjusts the batch size (as per operation 306) to reduce processing time of the batches, and/or to ensure that the latency requirement of the priority query can be met. The reduced batch size allows the priority request to be processed faster, without having to wait for the completion of a large number of non-priority tasks.

By reducing the batch size, the priority request is inserted into a smaller workload, which speeds up its processing time. As such, the GPU has fewer tasks to handle simultaneously, so that the GPU can allocate more immediate computational resources to the priority request.

The insertion process is dynamic, where the data platform continuously monitors the state of the current batch and finds an optimal point at which to insert the priority request. The data platform does not wait for the entire batch to complete before inserting the new request but instead interleaves the priority task with ongoing processes to minimize delay.

In some cases, when a priority query request is inserted into an ongoing batch of tasks on the GPU, the data platform does not need to reprocess any tasks that were already being worked on. The GPU can continue processing a first request (which was already in the batch before the insertion of the priority request) from where it left off by caching the state of the first request—including the progress made so far in terms of processing—in cache.

When the priority query request is inserted, the data platform pauses the first request, inserts the high-priority task into the batch, and then allows the GPU to resume processing of the first request from the point where it was paused based on the cached data simultaneously with the processing of the high-priority task.

This caching mechanism avoids inefficiencies that would otherwise arise from having to recompute or restart the first request from the beginning for the first request. By storing the intermediate results and current state of the task in cache, the GPU can quickly resume the original task after the priority query is completed. This approach ensures that the data platform can dynamically handle high-priority tasks without significantly delaying or disrupting the processing of other lower-priority requests, maintaining efficient GPU utilization and overall system performance.

In some cases, the data platform evicts requests when a priority query request is received and when the batch size on the GPU is dynamically reduced to meet latency requirements. The data platform makes decisions on removing certain requests (e.g., lower-priority requests) from the current batch to ensure that the priority request is processed efficiently.

When the batch size is reduced due to the latency requirement of a priority request, the data platform may need to remove one or more requests from the current batch that is being processed by the GPU. For example, if the original batch size was too large to accommodate the priority request, the data platform identifies a first request (such as a lower-priority or non-time-sensitive task) and removes it from the batch.

This ensures that the GPU can quickly process the priority query request without being delayed by the need to complete all the tasks in the original batch. The data platform thus handles high-priority tasks with reduced delay, which is particularly important in real-time systems where fast responses are needed.

In some examples, the data platform handles multiple requests in a batch and identifies which of these tasks can fit within the reduced batch size. The data platform identifies a plurality of requests in the current batch, which can be split into a first group of requests and a second group of requests.

The data platform determines whether the first group of requests and the priority query request can fit within the reduced batch size. This group typically can include high-priority or latency-sensitive tasks. The second group of requests, which cannot fit within the reduced batch size (such as lower-priority, non-urgent tasks), is then removed from the current batch.

This approach ensures that the priority query and other high-priority tasks are processed promptly, while non-priority tasks are deferred for later processing. By splitting the requests into groups, the data platform effectively manages both the latency requirements of critical tasks and the overall system throughput.

Once the second group of requests has been removed from the batch, the data platform assigns these retasks, such as to a scheduler for the GPU. The scheduler can reschedule these requests to be processed at a later time, when resources become available. The tasks are not discarded but are simply delayed, allowing the GPU to prioritize more urgent tasks.

This ensures that low-priority tasks are still completed, but without interfering with the processing of high-priority, time-sensitive requests. The scheduler manages the flow of tasks to the GPU, optimizing for system efficiency.

In some examples, the second group of requests that were removed from the current batch can be assigned to another GPU for processing. If the data platform has multiple GPUs available, the data platform may decide to offload the non-priority tasks to a different GPU that has available resources. This enables the data platform to process both high-priority and lower-priority tasks in parallel, without affecting the performance of the priority request.

This approach ensures optimal resource utilization across multiple GPUs, where the priority task can be handled by one GPU, while other less urgent tasks are sent to another GPU. This allows the system to balance both real-time processing and high-throughput batch processing without sacrificing efficiency.

In some cases, when the second group of requests is removed from the current batch, the second group can be sent to a GPU that is optimized for throughput. This other GPU can be designed to handle larger, less time-sensitive tasks in bulk.

The second batch, which includes these removed requests, can have a larger batch size compared to the reduced batch size of the current batch. This larger batch size allows the throughput-optimized GPU to process multiple requests efficiently, albeit with a longer processing time.

Meanwhile, the current batch—which includes the priority query request and other high-priority tasks—has a smaller, reduced batch size to ensure that the GPU can process it quickly and meet the latency requirements for these time-sensitive tasks. The smaller batch size of the current batch enables faster processing, ensuring that users receive quicker responses for interactive or urgent queries, while the second batch is processed more slowly but efficiently on a GPU geared toward handling large volumes of work.

As for a specific example, the data platform receives a question from a user “What is the latest news update on stock prices?” and the data platform assigns a high-priority status with a strict latency requirement. Meanwhile, the GPU is already processing a batch of lower-priority tasks, such as summarizing large datasets.

In this situation, the data platform can insert the stock price query into the current batch after reducing the batch size. This ensures that the query is processed immediately, allowing the system to generate and deliver a response quickly, without having to wait for all the other tasks in the batch to complete.

Although the priority query is inserted into the current batch, the data platform ensures that this does not unduly disrupt the overall flow of the batch. The platform uses a scheduler to balance the processing load, ensuring that the other tasks in the batch (such as lower-priority batch jobs) are still processed efficiently, though they may be slightly delayed to accommodate the high-priority request. The priority query request is handled with urgency, but the data platform still optimizes the rest of the batch to maintain overall GPU utilization and performance.

Once the priority query request is inserted into the current batch, the GPU processes the request alongside at least some of the remaining batch tasks. However, due to its high-priority status, the system ensures that the time to first token (TTFT) and time per output token (TPOT) for the priority task are minimized, allowing the query to be completed and the response sent to the user as quickly as possible, such as by reducing the batch size.

At operation 310, the data platform 102 receives the response from the GPU. Once the priority query request (and/or other tasks in the reduced batch) has been processed by the GPU, the system generates a response based on the computations performed. This response can include text, a data retrieval result, or some form of output relevant to the query.

For example, if the user asked a question like “What's the weather forecast for today?” through a chat interface, the GPU processes the request, retrieves the necessary data, and formats the response based on the LLM's inference.

The data platform then processes the received response further if needed, integrating the response with the user's original request, which can be performed by the same or a different separate LLM trained to generate natural language responses for the user.

At operation 312, the data platform 102 displays the response to the user via the communication interface. The data platform 102 takes the response received from the GPU and displays the response to the user through the communication interface. For example, in a chat application, the response might appear as a text message.

Since the original query was an interactive request, the data platform ensures that the response is displayed in real-time (or relatively quickly as compared to how long it would have taken otherwise) to meet the latency requirements established earlier in the process. By displaying the response promptly, the platform fulfills the user's expectation of receiving an immediate answer to their query.

In some cases, an interactive request can include a scenario where the output of one machine learning model (Model 1) is used as the input for another model (Model 2), creating a multi-stage pipeline. In this case, the data platform would assign a strict latency requirement to ensure that Model 1 completes its training or inference within a defined timeframe, so that Model 2 can begin processing without further delays. This is important to prevent bottlenecks where Model 2 would be idle, waiting for input, thus ensuring the entire training pipeline remains efficient and responsive. By enforcing a latency constraint, the platform can guarantee that the models in the pipeline process their respective stages without waiting indefinitely, maintaining smooth workflow and optimal system utilization.

Batch requests can include requests that are not time-sensitive and prioritize throughput over immediate response times. These tasks can involve processing large datasets where the primary goal is to maximize the amount of data processed in parallel, rather than delivering quick results.

For example, when handling tasks such as large dataset processing, the data platform can afford to use larger batch sizes to ensure optimal utilization of GPU resources. Since these requests lack strict timing constraints, the data platform can focus on achieving high throughput, allowing the GPU to process multiple requests simultaneously without sacrificing performance.

Examples of batch processing tasks can include machine learning model training, video rendering, and report generation. Machine learning models require substantial resources to process training data, where training may take hours or even days. Similarly, video rendering involves processing large media files, where speed is not critical as long as the end result is accurate and efficient. In data analytics or report generation, large datasets are analyzed or summarized, where the data platform prioritizes accuracy and completeness over the need for immediate results. These batch processes can run in the background, ensuring that real-time, interactive tasks do not experience performance degradation.

Batch requests could involve running large language models (LLMs) across tables in a data platform to perform tasks such as data translation or summarization. For instance, an LLM could be used to translate structured data into natural language descriptions or generate summaries from extensive datasets.

Batch tasks may include synthetic data generation for machine learning, or even training ML models on vast datasets to create more refined predictive models. As these tasks require extensive computational power but are not sensitive to immediate completion, they are perfectly suited for batch processing, where throughput and efficiency are prioritized over speed.

In some cases, the data platform distinguishes between interactive and batch requests based on one or more factors, which the data platform can then use to decrease batch sizes if interactive or increase batch sizes for batch requests, and/or reassign tasks accordingly.

In some cases, the data platform distinguishes between interactive and batch requests based on the amount of data throughput they require. In an interactive request, the data platform can determine that smaller amounts of data in real-time, with a focus on speed and low latency is required.

In some cases, the data platform can distinguish between request types based on the amount of data required to be processed, such as larger datasets with a focus on maximizing throughput, rather than speed for batch requests. The data platform may process substantial amounts of data at once—such as generating a report from historical data, summarizing large datasets, or training a machine learning model. These tasks are typically not time-sensitive and can afford to take longer, with the priority on processing as much data as possible in a single run.

Additionally, the distinction between interactive and batch requests can be determined based on client specific needs. A client may configure a system to handle smaller, real-time data queries interactively when they need immediate results, such as retrieving the latest customer information or asking for recent news updates. However, the same client could request a batch processing job to run extensive analyses, such as summarizing trends over several months of data or generating predictive models from large datasets. The flexibility to handle the same use case—such as data queries or chatbot interactions—both interactively and in batch mode allows for a more adaptable system that can balance speed and throughput based on client requirements and resource availability.

In some cases, a machine learning model can be used to control and balance between latency and throughput by dynamically adjusting system parameters and resource allocation based on real-time data and historical patterns. In environments where both interactive (latency-sensitive) and batch (throughput-focused) requests are processed, a machine learning model can be trained to learn from previous system performance to make intelligent decisions about how to allocate resources, such as GPUs, to meet different performance needs.

The machine learning model can continuously monitor system metrics, such as request volume, processing time, and resource availability, to predict upcoming workloads and adjust resource allocation accordingly. For example, during times of high demand for interactive requests, the machine learning model can dynamically prioritize low-latency tasks by reducing the batch size or reallocating resources from batch processing to interactive workloads. Conversely, when the system detects fewer interactive requests, the machine learning model can shift more resources towards batch processing, increasing throughput. The machine learning model can also monitor GPU utilization and predict when certain requests can be delayed without impacting overall performance, optimizing for both latency and throughput.

The machine learning model can also be used to develop predictive scheduling algorithms that learn from historical data to forecast when spikes in interactive or batch requests are likely to occur. By anticipating high-demand periods, the machine learning model can proactively adjust batch sizes, processing queues, and resource allocation to maintain a balance between speed (latency for interactive tasks) and volume (throughput for batch tasks). For example, if the machine learning model detects that interactive requests typically increase during certain hours or events, it can prioritize GPU resources for these tasks ahead of time, ensuring that the system remains responsive while still processing batch jobs in the background.

In some examples, the machine learning model is trained to continuously monitor request volume over time and predict upcoming requests and their types. By analyzing historical data and patterns, the model can forecast future spikes in traffic, including whether the requests will be interactive (latency-sensitive) or batch (throughput-focused). Using these predictions, the data platform can preemptively adjust batch sizes for the GPU, ensuring that sufficient resources are allocated to meet demand. This proactive adjustment helps the system maintain a balance between low latency for real-time requests and high throughput for large-scale batch processing, optimizing GPU utilization and overall performance.

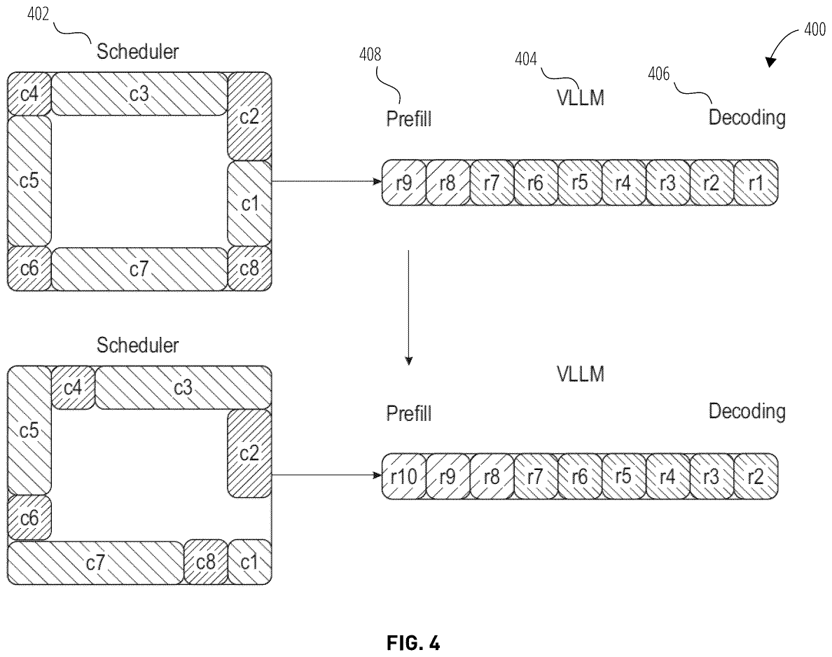

FIG. 4 illustrates an architectural diagram 400 illustrating scheduling tasks into a current batch for a GPU, according to some examples. In this figure, the scheduler 402 is responsible for managing and distributing tasks from customers C1-C8 to an LLM 404 that operates with a batch size of 9. The tasks in the batch are labeled as R1-R9, where each task represents a request (or a chunk of a request explained further herein) from one of the customers.

For a batch size of 9, the GPU can process up to nine requests at a time. In this case, the tasks R1-R9 have been selected by the scheduler to be processed together in this current batch.

Tasks R1-R7 are currently being processed or completed by the GPU in the “decoding” mode 406. This means that the GPU is fully engaged in computing the output tokens for these tasks. These tasks are at a stage where the model is currently processing the input tokens (the initial phase where the system interprets and transforms the input) and is now generating the final responses.

Tasks R8-R9 are in “prefill” mode 408, where these tasks have just been added to the batch by the scheduler but are not yet being processed like R1-R7. In prefill mode, the GPU is computing the input tokens for these tasks. This is the initial phase of processing where the model begins by encoding the inputs (e.g., transforming the text into vector embeddings) in preparation for the subsequent stages of response generation.

In the next step of the figure, the data platform has progressed in the batch processing cycle. R1 has been fully processed by the GPU and removed from the current batch. The GPU has completed generating the output tokens for the task associated with R1, and the result has been delivered or is ready to be delivered to the requester.

In this example, the batch size has now reduced by one task. R10, which corresponds to a request from C1, is the next in line and has now been added to the batch. The scheduler has selected R10 to replace R1 and R10 will begin the process of prefilling.

R8 and R9 are still in the prefill phase, where the GPU is continuing to compute the input tokens for these tasks. They have not yet reached the stage where output tokens are generated. The system is still preparing these tasks for full processing, and they will soon enter the active processing phase once their inputs are ready.

The GPU is now generating outputs for tasks R2-R7. The GPU is fully engaged in creating the output tokens for these requests. Once R2-R7 are fully processed, they will be removed from the batch in subsequent steps, and new tasks (like R8, R9, and R10) will progress from prefill mode to the output generation phase. As tasks are completed and removed from the batch, the scheduler will continue to add new tasks (like R10) to ensure that the GPU is always fully utilized, minimizing idle time and optimizing throughput.

In some examples, the data platform performs task chunking by breaking down large tasks into smaller, manageable portions, which can be processed independently or sequentially. In a data platform where the GPU has a limited batch size, chunking tasks allows the scheduler to dynamically allocate portions of tasks into the available space in the batch. This approach helps optimize GPU utilization by filling any gaps that become available when other tasks are completed or partially processed.

Tasks can be divided into smaller chunks or subtasks. Each chunk represents a fraction of the overall task and can be processed independently, allowing the GPU to handle portions of the larger task as space becomes available.

The scheduler monitors the availability of resources (e.g., GPU capacity) in real-time. When a batch is being processed and space becomes available—either because a task has been fully processed or a portion of a task has completed—the scheduler identifies chunks that are waiting to be processed. As soon as space opens up in the batch, the scheduler adds the next chunk from a task to the current batch. This could include new tasks that have just been scheduled or incomplete tasks that are waiting for their remaining chunks to be processed. For example, R1-R10 could be chunks of one or more requests.

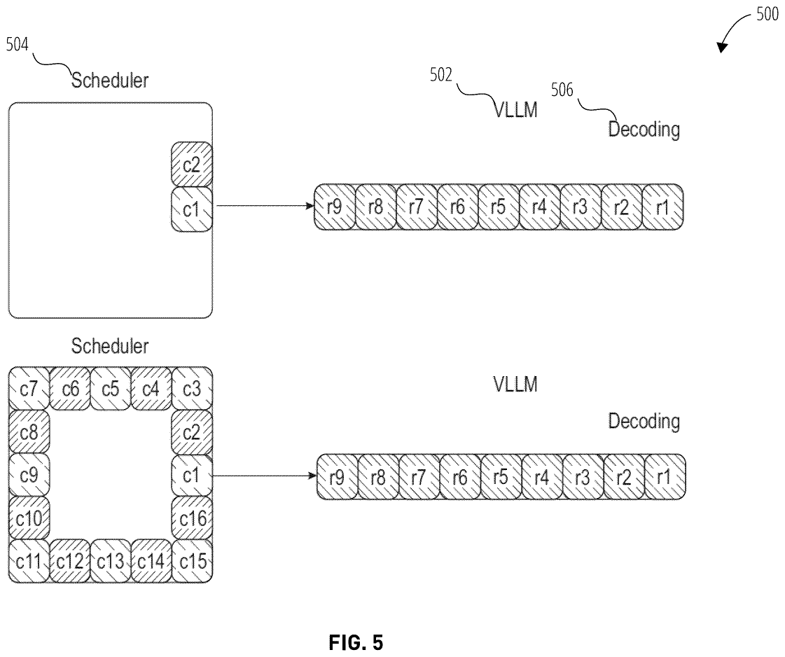

FIG. 5 illustrates an architectural diagram 500 illustrating new incoming requests added to the scheduler, according to some examples. R1-R9 are currently being decoded 506 by the LLM 502, while C1-C2 are waiting at the scheduler 504.

In the next time step, new requests from C3-C16 arrive and are added to the system. The scheduler can process these tasks in a First In, First Out (FIFO) where once one of the tasks R1-R9 are completed, the request from C1 can be assigned to the current batch.

In other cases, the scheduler can use a different process than FIFO to manage task assignment more effectively depending on factors like priority, resource optimization, and system constraints. The scheduler can assign tasks based on their priority level rather than arrival time.

Requests that are marked as higher priority—perhaps due to stricter latency requirements, customer service level agreements (SLAs), or mission-critical tasks—are processed first. For instance, if C4 is a high-priority request while C1-C3 are low-priority batch tasks, the scheduler could process C4 before other tasks in the queue. This ensures that time-sensitive or more important requests are handled promptly.

The scheduler can assign tasks using round-robin by assigning tasks in a cyclical manner, ensuring that each request gets an equal share of processing time or attention from the system. In this approach, the scheduler would rotate between requests from different customers or sources. For example, after assigning C1, the scheduler would move to C2, then C3, and so on, repeating the cycle.

In Shortest Job First scheduling, the scheduler prioritizes tasks that require the least processing time. This reduces the average wait time for the system and increases overall throughput, especially when smaller tasks can be completed quickly. For example, if C5 is a quick request that requires minimal resources, the scheduler may process it before C1-C4, which could be more resource-intensive. The system can quickly clear smaller tasks and free up capacity for larger ones.

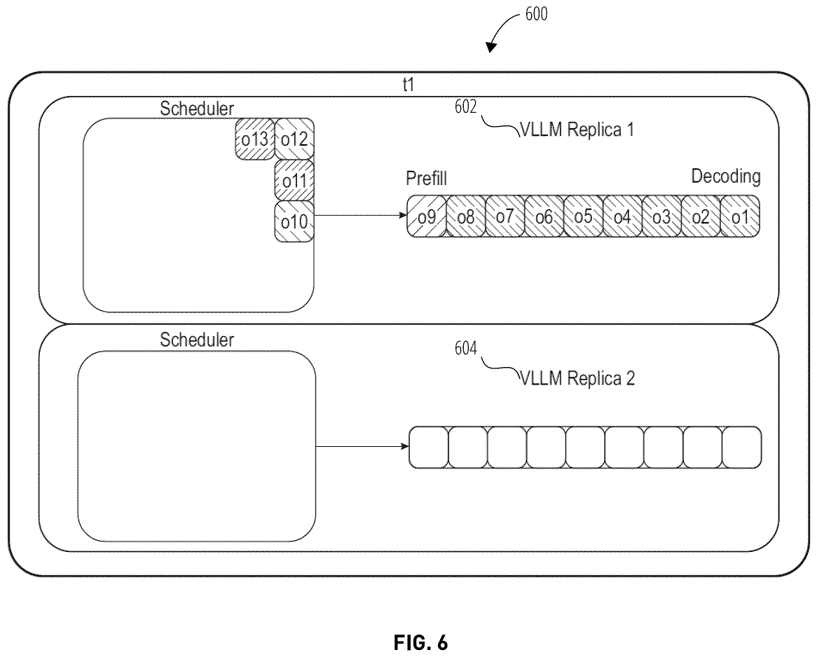

FIG. 6 illustrates an architectural diagram 600 illustrating the processing of tasks via a first LLM replica and no tasks processed by a second LLM replica, according to some examples. In this figure, the data platform is managing two LLM replicas, each assigned to separate GPU nodes.

The first LLM replica 602 is currently processing a batch of tasks o1-o9. o1-o8 are in the decoding phase. The LLM is working through these tasks to produce final responses based on the input tokens that were prefilled earlier. o9 is in the prefill phase, where the task is being prepared for full processing, but it hasn't reached the decoding stage yet.

The scheduler for Replica 1 has additional tasks o10-o13 waiting in line. These tasks have been queued by the scheduler and will be assigned to the batch as soon as processing space becomes available—either when a task finishes or moves beyond the prefill stage.

Unlike the first LLM replica, the second LLM replica 604 has no tasks currently being processed. The GPU assigned to this replica is idle, meaning that it is underutilized at this point. Additionally, the scheduler for the second LLM replica has no tasks waiting to be processed. This leaves the second LLM replica completely idle, with no requests being assigned or queued for processing.

In this scenario, we observe a load imbalance between the two replicas. The first LLM replica is fully engaged with tasks and has a queue of tasks waiting, while the second LLM replica is idle with no tasks in the pipeline.

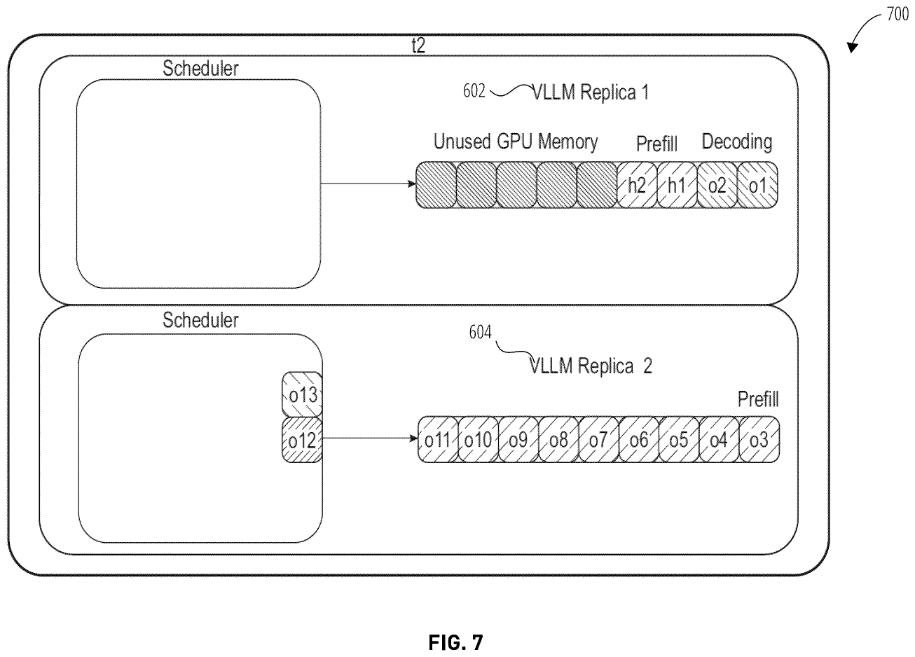

FIG. 7 illustrates an architectural diagram 700 illustrating the application of latency requirements and strategic distribution of tasks and batch sizes responsive to new incoming tasks, according to some examples. In this figure, the data platform adapts to the strict latency requirements of new incoming tasks h1-h2 by making strategic changes to both the batch size and the distribution of tasks across the two replicas.

The first LLM replica reduces its batch size to 4 units to prioritize h1-h2, which have strict latency requirements. By reducing the batch size, the GPU can process these latency-sensitive tasks more quickly, minimizing delay. h1-h2 are then assigned to the first LLM replica for immediate processing, allowing the system to meet the tight deadlines associated with these tasks.

Tasks o1-o2, which were already being processed by the first replica, remain in the current batch of the first LLM replica. However, since o3-o9 are non-time-sensitive tasks (with less stringent latency requirements), they are moved to the second LLM replica.

The second LLM replica now processes a batch with a size of 9 units (which is larger than the first LLM replica's reduced batch size) because its priority is throughput, not speed. This allows the second LLM replica to handle the less urgent tasks efficiently without needing to reduce batch size.

In addition to the reassigned tasks o3-o9, new tasks o10-o11 are also added to the batch of the second LLM replica. This increases the workload of the second LLM replica, which is geared towards processing larger, non-urgent batches efficiently. Since these tasks are not subject to strict latency requirements, they can be processed at a normal pace, maximizing the throughput on the second LLM replica.

Tasks o12-o13 are added to the scheduler for the second LLM replica, waiting for the next available slot to be processed once there is room in the batch. This scheduling ensures that the second LLM replica is continuously utilized and processes tasks in an efficient, sequential manner.

The first LLM replica reduces its batch size to 4 units, prioritizing h1-h2 (latency-sensitive tasks) and keeping o1-o2 in the current batch. The second LLM replica takes over processing the non-latency-sensitive tasks o3-o9 and adds o10-o11 to its current batch, which remains at a size of 9 units. o12-o13 are queued in the scheduler for the second LLM replica, ready to be processed once space becomes available in future batches.

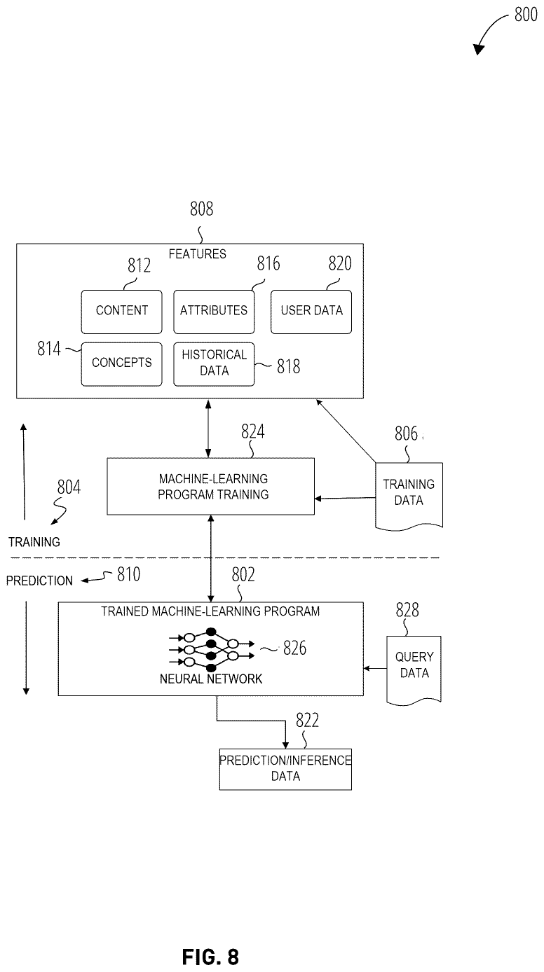

FIG. 8 illustrates further details of two example phases, namely a training phase 804 (e.g., part of the model selection and training 906) and a prediction phase 810 (part of prediction 910). Prior to the training phase 804, feature engineering 904 is used to identify features 808. This may include identifying informative, discriminating, and independent features for effectively operating the trained machine-learning program 802 in pattern recognition, classification, and regression. In some examples, the training data 806 includes labeled data, known for pre-identified features 808 and one or more outcomes. Each of the features 808 may be a variable or attribute, such as an individual measurable property of a process, article, system, or phenomenon represented by a data set (e.g., the training data 806). Features 808 may also be of different types, such as numeric features, strings, and graphs, and may include one or more of content 812, concepts 814, attributes 816, historical data 818, and/or user data 820, merely for example.

In training phase 804, the machine-learning pipeline 800 uses the training data 806 to find correlations among the features 808 that affect a predicted outcome or prediction/inference data 822.

With the training data 806 and the identified features 808, the trained machine-learning program 802 is trained during the training phase 804 during machine-learning program training 824. The machine-learning program training 824 appraises values of the features 808 as they correlate to the training data 806. The result of the training is the trained machine-learning program 802 (e.g., a trained or learned model).

Further, the training phase 804 may involve machine learning, in which the training data 806 is structured (e.g., labeled during preprocessing operations). The trained machine-learning program 802 implements a neural network 826 capable of performing, for example, classification and clustering operations. In other examples, the training phase 804 may involve deep learning, in which the training data 806 is unstructured, and the trained machine-learning program 802 implements a deep neural network 826 that can perform both feature extraction and classification/clustering operations.

In some examples, a neural network 826 may be generated during the training phase 804 and implemented within the trained machine-learning program 802. The neural network 826 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 826 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 826 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 804, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 810, the trained machine-learning program 802 uses the features 808 for analyzing query data 828 to generate inferences, outcomes, or predictions, as examples of a prediction/inference data 822. For example, during prediction phase 810, the trained machine-learning program 802 generates an output. Query data 828 is provided as an input to the trained machine-learning program 802, and the trained machine-learning program 802 generates the prediction/inference data 822 as output, responsive to receipt of the query data 828.

In some examples, the trained machine-learning program 802 may be a generative AI model. Generative AI is a term that may refer to any type of artificial intelligence that can create new content from training data 806. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like.

For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 822 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, eXtensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a cloud data platform 102 can include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A cloud data platform 102 may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a cloud data platform 102, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

In the present disclosure, physical units of data that are stored in a cloud data platform—and that make up the content of, e.g., database tables in customer accounts (e.g., customer users)—are referred to as micro-partitions. In different implementations, a cloud data platform can store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the cloud data platform, a given file is referred to herein as an “internal file” and may be stored in (or at, or on, etc.) what is referred to herein as an “internal storage location.” If stored external to the cloud data platform, a given file is referred to herein as an “external file” and is referred to as being stored in (or at, or on, etc.) what is referred to herein as an “external storage location.”

While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

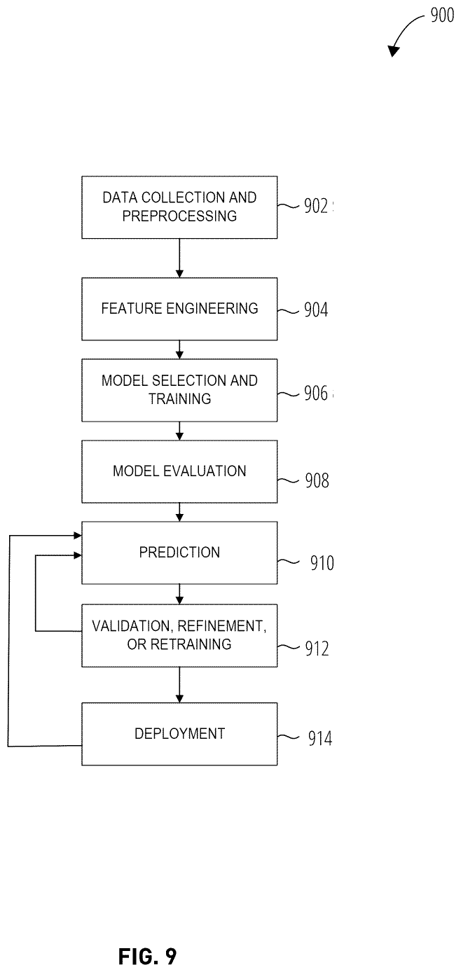

FIG. 9 depicts a machine-learning pipeline 900 and FIG. 9 illustrates training and use of a machine-learning program (e.g., model) 800. Specifically, FIG. 9 is a flowchart depicting a machine-learning pipeline 900, according to some examples. The machine-learning pipeline 900 can be used to generate a trained model, for example the trained machine-learning program 802 of FIG. 8, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include linear regression, decision trees, and neural networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 804 as described and depicted in connection with FIG. 9, generating a trained machine-learning program 802 may include multiple phases that form part of the machine-learning pipeline 900, including for example the following phases illustrated in FIG. 9: data collection and preprocessing 902, feature engineering 904, model selection and training 906, model evaluation 908, prediction 910, validation, refinement, or retraining 912, and deployment 914, or a combination thereof.

For example, data collection and preprocessing 902 can include a phase for acquiring and cleaning data to ensure that it is suitable for use in the machine learning model. This phase may also include removing duplicates, handling missing values, and converting data into a suitable format. Feature engineering 904 can include a phase for selecting and transforming the training data 806 to create features that are useful for predicting the target variable. Feature engineering may include (1) receiving features 808 (e.g., as structured or labeled data in supervised learning) and/or (2) identifying features 808 (e.g., unstructured, or unlabeled data for unsupervised learning) in training data 806. Model selection and training 906 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 908 can include a phase for evaluating the performance of a trained model (e.g., the trained machine-learning program 802) on a separate testing dataset. This phase can help determine if the model is overfitting or underfitting and determine whether the model is suitable for deployment. Prediction 910 can include a phase for using a trained model (e.g., trained machine-learning program 802) to generate predictions on new, unseen data. Validation, refinement or retraining 912 can include a phase for updating a model based on feedback generated from the prediction phase, such as new data or user feedback. Deployment 914 can include a phase for integrating the trained model (e.g., the trained machine-learning program 802) into a more extensive system or application, such as a web service, mobile app, or IoT device. This phase can involve setting up APIs, building a user interface, and ensuring that the model is scalable and can handle large volumes of data.

In view of the disclosure above, various examples are set forth below. It should be noted that one or more features of an example, taken in isolation or combination, should be considered within the disclosure of this application.

Example 1 is a computer system comprising: at least one hardware processor; and at least one memory storing instructions that cause the at least one hardware processor to perform operations comprising: receiving, from a user, an interactive request via a communication interface of a data platform, the interactive request comprising a question requesting a response from the communication interface; generating a priority query request corresponding to the interactive request with a latency requirement indicating a maximum allowable time to generate a response to the interactive request; reducing, based on the latency requirement, a batch size on a graphical processing unit (GPU) executing multiple workloads of a large language model (LLM); inserting the priority query request into a current batch being processed by the GPU based on the reduced batch size; receiving the response from the GPU; and displaying the response to the user via the communication interface.

In Example 2, the subject matter of Example 1 includes, wherein the operations further comprise: determining the latency requirement based on a content of the question received via the communication interface.

In Example 3, the subject matter of Examples 1-2 includes, wherein the operations further comprise: determining the latency requirement based on a complexity factor of the question, the complexity factor being associated with an amount of data to be assessed in order to respond to the question.

In Example 4, the subject matter of Examples 1-3 includes, wherein the operations further comprise: determining the latency requirement based on a complexity factor of the question, the complexity factor being associated with a number of operations to be performed on data in order to respond to the question.

In Example 5, the subject matter of Examples 1-4 includes, wherein reducing the batch size of the GPU is based on a current size of a queue in a scheduler for the GPU.

In Example 6, the subject matter of Examples 1-5 includes, wherein the priority query request is inserted into the current batch prior to the current batch that is currently being processed by the GPU has completed tasks previously assigned to the current batch.

In Example 7, the subject matter of Examples 1-6 includes, wherein the GPU continuously processes a first request that was in the current batch prior to the insertion of the priority query request without having to perform reprocessing of the first request as a result of the insertion of the priority query request.

In Example 8, the subject matter of Example 7 includes, wherein the operations further comprise: storing a current state of the first request in cache prior to the insertion of the priority query request; and subsequent to the insertion of the priority query request, processing the priority query request and the first request simultaneously, wherein processing the first request without having to perform reprocessing of the first request is based on the stored cache of the current state of the first request.

In Example 9, the subject matter of Examples 1-8 includes, wherein the operations further comprise: removing a first request in the current batch in response to the reduced batch size.

In Example 10, the subject matter of Example 9 includes, wherein the operations further comprise: identifying a plurality of requests in the current batch, the plurality of requests comprising a first group of requests and a second group of requests, the first group of requests comprising the first request; determining the first group of requests of the plurality of requests and the priority request fit within the reduced batch size; removing second group of requests from the current batch; and initiate processing of the first group of requests with the priority request by the GPU.

In Example 11, the subject matter of Example 10 includes, wherein the second group of requests are assigned to a scheduler for the GPU.

In Example 12, the subject matter of Examples 10-11 includes, wherein the second group of requests are assigned to another batch for processing by another GPU.

In Example 13, the subject matter of Example 12 includes, wherein the second batch size for the second batch is greater than the reduced batch size for the current batch, wherein the current batch is processed faster than the second batch.

In Example 14, the subject matter of Examples 1-13 includes, wherein the operations further comprise: determining a latency and throughput metric based on at least one task assigned to the current batch and the priority query request by processing the at least one task assigned to the current batch and the priority query request using a machine learning model trained to dynamically adjust current batch sizes of the GPU based on the latency and throughput metric.

In Example 15, the subject matter of Example 14 includes, wherein the machine learning model is trained to continuously monitors request volume over time to predict upcoming request and request types in order to preemptively adjust batch sizes for the GPU.

In Example 16, the subject matter of Examples 1-15 includes, wherein the operations further comprise: dividing the priority query request into a plurality of chunks comprising a first chunk and a second chunk; and assigning the first chunk to a scheduler of the GPU; wherein inserting the priority query request into the current batch comprises inserting the second chunk into the current batch.

Example 17 is a method performed by at least one hardware processor, the method comprising: receiving, from a user, an interactive request via a communication interface of a data platform, the interactive request comprising a question requesting a response from the communication interface; generating a priority query request corresponding to the interactive request with a latency requirement indicating a maximum allowable time to generate a response to the interactive request; reducing, based on the latency requirement, a batch size on a graphical processing unit (GPU) executing multiple workloads of a large language model (LLM); inserting the priority query request into a current batch being processed by the GPU based on the reduced batch size; receiving the response from the GPU; and displaying the response to the user via the communication interface.

In Example 18, the subject matter of Example 17 includes, wherein the method further comprises determining the latency requirement based on a content of the question received via the communication interface.

In Example 19, the subject matter of Examples 17-18 includes, wherein the method further comprises determining the latency requirement based on a complexity factor of the question, the complexity factor being associated with an amount of data to be assessed in order to respond to the question.

Example 20 is computer-storage media comprising instructions that, when executed by one or more processors of a machine, configure the machine to perform operations comprising: receiving, from a user, an interactive request via a communication interface of a data platform, the interactive request comprising a question requesting a response from the communication interface; generating a priority query request corresponding to the interactive request with a latency requirement indicating a maximum allowable time to generate a response to the interactive request; reducing, based on the latency requirement, a batch size on a graphical processing unit (GPU) executing multiple workloads of a large language model (LLM); inserting the priority query request into a current batch being processed by the GPU based on the reduced batch size; receiving the response from the GPU; and displaying the response to the user via the communication interface.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20. Example 23 is a system to implement any of Examples 1-20.

Example 24 is a method to implement any of Examples 1-20.

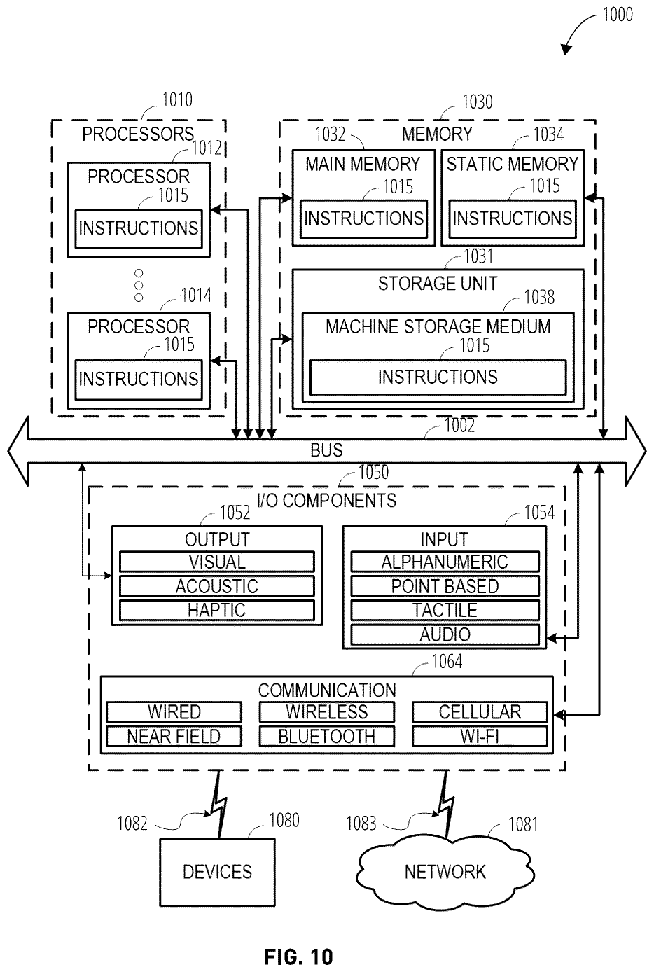

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1015 (e.g., software, a program, an application, an applet, an app, or other executable code), for causing the machine 1000 to perform any one or more of the methodologies discussed herein, may be executed. For example, the instructions 1015 may cause the machine 1000 to implement portions of the data flows described herein (e.g., data flows described and depicted in FIG. 10). In this way, the instructions 1015 transform a general, non-programmed machine into a particular machine 1000 (e.g., the client device 112 of FIG. 1, the compute service manager 108 of FIG. 1, the execution platform 110 of FIG. 1) that is specially configured to carry out any one of the described and illustrated functions in the manner described herein.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1015, sequentially or otherwise, that specify actions to be taken by the machine 1000. Further, while only a single machine 1000 is illustrated, the term “machine” shall also be taken to include a collection of machines 1000 that individually or jointly execute the instructions 1015 to perform any one or more of the methodologies discussed herein.

The machine 1000 includes processors 1010 (such as processor 1012 and processor 1014), memory 1030, and input/output (I/O) I/O components 1050 (including output components 1052 and input components 1054) configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1015. The term “processor” is intended to include multi-core processors 1010 that may comprise two or more independent processors (sometimes referred to as “cores”) that may execute instructions 1015 contemporaneously. Although FIG. 10 shows multiple processors 1010, the machine 1000 may include a single processor with a single core, a single processor with multiple cores (e.g., a multi-core processor), multiple processors with a single core, multiple processors with multiple cores, or any combination thereof.

The memory 1030 may include a main memory 1032, a static memory 1034, and a storage unit 1031, all accessible to the processors 1010 such as via the bus 1002. The main memory 1032, the static memory 1034, and the storage unit 1031 comprise a machine storage medium 1038 that may store the instructions 1015 embodying any one or more of the methodologies or functions described herein. The instructions 1015 may also reside, completely or partially, within the main memory 1032, within the static memory 1034, within the storage unit 1031, within at least one of the processors 1010 (e.g., within the processor's cache memory), or any suitable combination thereof, during execution thereof by the machine 1000.

The I/O components 1050 include components to receive input, provide output, produce output, transmit information, exchange information, capture measurements, and so on. The specific I/O components 1050 that are included in a particular machine 1000 will depend on the type of machine. For example, portable machines, such as mobile phones, will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1050 may include communication components 1064 operable to couple the machine machine 1000 to a network 1081 via a coupler 1083 or to devices 1080 via a coupling 1082. For example, the communication components 1064 may include a network interface component or another suitable device to interface with the network 1081. In further examples, the communication components 1064 may include wired communication components, wireless communication components, cellular communication components, and other communication components to provide communication via other modalities. The devices 1080 may be another machine or any of a wide variety of peripheral devices (e.g., a peripheral device coupled via a universal serial bus (USB)). For example, as noted above, the machine 1000 may correspond to any one of the client device 112, the compute service manager 108, and the execution platform 110, and may include any other of these systems and devices.

The various memories (e.g., 1030, 1032, 1034, and/or memory of the processor(s) 1010 and/or the storage unit 1031) may store one or more sets of instructions 1015 and data structures (e.g., software), embodying or utilized by any one or more of the methodologies or functions described herein. These instructions 1015, when executed by the processor(s) 1010, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1081 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1081 or a portion of the network 1081 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1015 may be transmitted or received over the network 1081 using a transmission medium via a network interface device (e.g., a network interface component included in the communication components 1064) and utilizing any one of a number of well-known transfer protocols (e.g., hypertext transfer protocol (HTTP)). Similarly, the instructions 1015 may be transmitted or received using a transmission medium via the coupling 1082 (e.g., a peer-to-peer coupling) to the devices 1080. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1015 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A computer system comprising:
at least one hardware processor; and
at least one memory storing instructions that cause the at least one hardware processor to perform operations comprising:
receiving, from a user, an interactive request via a communication interface of a data platform, the interactive request comprising a question requesting a response from the communication interface;
generating a priority query request corresponding to the interactive request with a latency requirement indicating a maximum allowable time to generate a response to the interactive request;
reducing, based on the latency requirement, a batch size on a graphical processing unit (GPU) executing multiple workloads of a large language model (LLM);
inserting the priority query request into a current batch being processed by the GPU based on the reduced batch size;
receiving the response from the GPU; and
displaying the response to the user via the communication interface.

2. The computer system of claim 1, wherein the operations further comprise:
determining the latency requirement based on a content of the question received via the communication interface.

3. The computer system of claim 1, wherein the operations further comprise:
determining the latency requirement based on an amount of data to be assessed in order to respond to the question.

4. The computer system of claim 1, wherein the operations further comprise:
determining the latency requirement based on a complexity factor of the question, the complexity factor being associated with a number of operations to be performed on data in order to respond to the question.

5. The computer system of claim 1, wherein reducing the batch size of the GPU is based on a current size of a queue in a scheduler for the GPU.

6. The computer system of claim 1, wherein the priority query request is inserted into the current batch prior to the current batch that is currently being processed by the GPU has completed tasks previously assigned to the current batch.

7. The computer system of claim 1, wherein the GPU continuously processes a first request that was in the current batch prior to the insertion of the priority query request without having to perform reprocessing of the first request as a result of the insertion of the priority query request.

8. The computer system of claim 7, wherein the operations further comprise:
storing a current state of the first request in cache prior to the insertion of the priority query request; and
subsequent to the insertion of the priority query request, processing the priority query request and the first request simultaneously, wherein processing the first request without having to perform reprocessing of the first request is based on the stored cache of the current state of the first request.

9. The computer system of claim 1, wherein the operations further comprise:
removing a first request in the current batch in response to the reduced batch size.

10. The computer system of claim 9, wherein the operations further comprise:
identifying a plurality of requests in the current batch, the plurality of requests comprising a first group of requests and a second group of requests, the first group of requests comprising the first request;
determining the first group of requests of the plurality of requests and the priority request fit within the reduced batch size;
removing second group of requests from the current batch; and
initiate processing of the first group of requests with the priority request by the GPU.

11. The computer system of claim 10, wherein the second group of requests are assigned to a scheduler for the GPU.

12. The computer system of claim 10, wherein the second group of requests are assigned to another batch for processing by another GPU.

13. The computer system of claim 12, wherein the second batch size for the second batch is greater than the reduced batch size for the current batch, wherein the current batch is processed faster than the second batch.

14. The computer system of claim 1, wherein the operations further comprise:
determining a latency and throughput metric based on at least one task assigned to the current batch and the priority query request by processing the at least one task assigned to the current batch and the priority query request using a machine learning model trained to dynamically adjust current batch sizes of the GPU based on the latency and throughput metric.

15. The computer system of claim 14, wherein the machine learning model is trained to continuously monitor request volume over time to predict upcoming request and request types in order to preemptively adjust batch sizes for the GPU.

16. The computer system of claim 1, wherein the operations further comprise:
dividing the priority query request into a plurality of chunks comprising a first chunk and a second chunk; and
assigning the first chunk to a scheduler of the GPU;
wherein inserting the priority query request into the current batch comprises inserting the second chunk into the current batch.

17. A method performed by at least one hardware processor, the method comprising:
receiving, from a user, an interactive request via a communication interface of a data platform, the interactive request comprising a question requesting a response from the communication interface;
generating a priority query request corresponding to the interactive request with a latency requirement indicating a maximum allowable time to generate a response to the interactive request;
reducing, based on the latency requirement, a batch size on a graphical processing unit (GPU) executing multiple workloads of a large language model (LLM);
inserting the priority query request into a current batch being processed by the GPU based on the reduced batch size;
receiving the response from the GPU; and
displaying the response to the user via the communication interface.

18. The method of claim 17, wherein the method further comprises determining the latency requirement based on a content of the question received via the communication interface.

19. The method of claim 17, wherein the method further comprises determining the latency requirement based on a complexity factor of the question, the complexity factor being associated with an amount of data to be assessed in order to respond to the question.

20. Computer-storage media comprising instructions that, when executed by one or more processors of a machine, configure the machine to perform operations comprising:
receiving, from a user, an interactive request via a communication interface of a data platform, the interactive request comprising a question requesting a response from the communication interface;
generating a priority query request corresponding to the interactive request with a latency requirement indicating a maximum allowable time to generate a response to the interactive request;
reducing, based on the latency requirement, a batch size on a graphical processing unit (GPU) executing multiple workloads of a large language model (LLM);
inserting the priority query request into a current batch being processed by the GPU based on the reduced batch size;
receiving the response from the GPU; and
displaying the response to the user via the communication interface.
